(19) United States
(12) Patent Application Publication
(10) Pub. No.: US 2005/0157881 A1
(43) Pub. Date: Jul. 21, 2005

(54) Cryptographic security module method and apparatus

(75) Inventor: Nicholas Benedict Van Someren, Cambridge (GB)

Correspondence Address: SEED INTELLECTUAL PROPERTY LAW GROUP PLLC, 701 FIFTH AVE, SUITE 6300, SEATTLE, WA, 98104-7092, US

(73) Assignee: nCipher Corporation Ltd., Cambridge (GB)

(21) Appl. No.: 11/012,057

(22) Filed: Dec. 14, 2004

(30) Foreign Application Priority Data
Dec. 15, 2003 (GB) 0329039.2

(51) Int. Cl. H04L 9/00

(52) U.S. Cl. 380/286

(57) ABSTRACT

A cryptographic security module holds a cryptographic key having a private part and a public part. The private part is held within the module and is usable only to sign messages generated within the module. The public part can be extracted from the module and is usable by a warranting authority to generate a warrant for the module. The module may be used to generate a new key and the private part of the cryptographic key used to generate a key-generation certificate by signing a key-generation message containing information by which the new key can be identified.

### BACKGROUND OF THE INVENTION

1. Field of the Invention

The invention relates to a cryptographic security module method and apparatus, and particularly to the warranting of a security module and a key generated by a security module.

2. Description of the Related Art

It is generally accepted in the field of computer security that it is best practice for cryptographic keys to be generated and stored in special-purpose hardware, namely hardware security modules. Tamper-proof software security modules can also be used, usually in less exacting applications.

The use of security modules aims to exert the tightest possible control over the generation, use and movement of cryptographic keys.

When carrying out business secured by cryptographic systems, such as internet banking, electronic commerce or a variety of other systems, it is important for each of the parties involved to be able to gain an informed view of the risks to which they are exposed. One source of risk arises from the cryptographic procedures used by other parties and the circumstances under which other parties generate and manage cryptographic keys. The invention aims to address the problem of assessing this risk.

### BRIEF SUMMARY OF THE INVENTION

The invention provides, in its various aspects, a cryptographic security module, a method for operating a module, a key-generation certificate, a method for warranting a module, a warrant and a verification method as defined in the appended independent claims. Preferred or advantageous features of the invention are set out in dependent sub-claims.

The invention may thus advantageously provide a method for warranting a cryptographic security module, such as a hardware security module or a tamper-proof software security module, for example so that a user, or consumer, of a key generated by the module can have increased knowledge of the circumstances of the generation and management of the key. Thus, for example, the consumer may be able to have assurance that other parties in a cryptographic system are following best practices, or to evaluate what practices are being followed and therefore what risk he is taking. In its various aspects the invention may thus provide a variety of new, high-assurance cryptographic services.

The following description of the invention in its various aspects refers to the parties, or participants, listed below. It is important to appreciate, however, that in any implementation of the invention some of the participants may take on more than one role; that is, the same person or organization may represent more than one of the listed parties. In addition, not all of the listed parties may be involved in any individual implementation of the invention.

Manufacturer: constructs security modules, or co-ordinates sub-contractors to do so, either to the manufacturer's own design or to other designs.

Warranting Authority: examines new security modules and issues warrants for modules that it deems to satisfy predetermined criteria or standards.

Key Generator: uses a security module to generate one or more cryptographic keys.

Prover: examines and verifies key generation evidence.

Certification Service: may issue statements about the source of a key.

Consumer: uses a key and wishes to know about its source.

Any party may choose to subcontract some sub-set of the activities listed above, but as the skilled man would appreciate this makes no qualitative difference to the operation of the invention. For brevity, the systems and methods of the invention will therefore be described as if all of the parties carry out their functions themselves.

In a first aspect, the invention may advantageously provide a cryptographic security module and a method for operating a module as follows. The module holds a key having a private part and a public part. The private part is held securely within the module and the public part can be extracted from the module. The private part is usable only to sign messages within the module. The key may therefore be termed a warrantable key because its public part can be used by a warranting authority, on examining the module, to generate a warrant. The warrant may then form a basis for informing a consumer as to the source of messages signed by the warrantable key.

The module may advantageously be used to generate a new key, and may then generate a key-generation certificate by using the warrantable key to sign, either directly or indirectly through one or more levels of indirection, a key-generation message containing information by which the new key can be identified.

The warrant issued by the warranting authority preferably contains information identifying the public part of the warrantable key, which may then be used to verify the key-generation certificate and give assurance that the key identified in the key-generation certificate was generated by the security module associated with the warrant.

In an alternative embodiment of the invention, the key-generation certificate may contain not only information by which the newly-generated key can be identified but may also contain other information such as the parameters used for the key generation and any access-control parameters attached to the resulting key.

In a further alternative embodiment, information in the key-generation certificate and/or in the warrant may be in the form of cryptographic hash values or other digests which may be used to validate the information, without including the information itself in the key-generation certificate or warrant. The information itself would then, for example, accompany the key-generation certificate or warrant.

In an alternative embodiment involving indirect signature of the key-generation certificate, the warrantable key stored within the security module may be used to sign a message describing a state of the security module, the message including identification of another key which can be used solely for the purpose of signing messages generated inside the security module, including key-generation messages as described above. This may be further extended to include more than one level of indirection in which the stored warrantable key and other intermediate keys each sign a sequence of messages attesting to a state of the system and the validity of the next key, up to the last key, which can be used for signing key-generation messages to form key-generation certificates.

In its various aspects, the invention may thus enable a chain of evidence to be created linking a key to the security module which generated it, and optionally attesting to associated information pertaining to the key, such as key-generation parameters or access-control parameters. Key-generation parameters might include details of the key length, the strictness requirements for the choice of random number used in generating the key or the prime number strength used in generating the key. Access control information may, for example, identify parties who have access to the key or a level of security above which parties may have access.

A further aspect of the invention relates to the warranting of a cryptographic security module. This may be carried out by a warranting authority and involve assessing the module and generating a warrant attesting that, in the opinion of the warranting authority, the module has been authenticated against a predetermined standard. The warranting authority may advantageously be independent of the manufacturer in this aspect of the invention.

In a preferred embodiment, the warranting authority is in possession of a cryptographic digital signature key known as a warranting key. The warranting authority undertakes to use this key only for signing warrants. The warranting authority examines a security module, for example comparing it to design information provided by the manufacturer of the module or comparing it to another predetermined design or security standard. Design information might provide physical design details (for a hardware security module), details of the software or firmware of the module, or other information that may help to ensure that the warranting authority knows that the module in hand has been built according to the predetermined design or to the predetermined standard and has not been altered in any way. Once the warranting authority is convinced of the authenticity of the module to a predetermined degree of certainty, it may ensure that the module contains a warrantable key, extract the public part of that key and generate a digital warrant message which contains information identifying the public part of the warrantable key and that the warrantable key belongs to a security module that has satisfied the predetermined tests applied by the warranting authority. The warrant message may also include information identifying the security module, such as its serial number, model number and any other appropriate ancillary information. The warranting authority may then digitally sign the warrant message using the private part of the warranting key to produce a warrant.

Such a warrant therefore attests at least that the public part of the warrantable key identified in the warrant belongs to a security module in which the private part of the warrantable key is held with a predetermined level of security and can only be used for signing messages generated within the module, either directly or indirectly through one or more levels of indirection. If a message signed by the warrantable key is received, the warrant can be used to identify the public key needed to verify the message and thus to attest that the message was generated within a warranted security module.

The warrant preferably contains information identifying the security module. It may also advantageously provide information as to the level of security provided by the module, for example with reference to the design of the module or a predetermined standard against which the module has been authenticated or tested.

The warrant may contain either the public part of the warrantable key itself and/or other information as discussed above, or cryptographic hash values or other digests which may be used to validate this information without including it in the warrant itself. The information may then be provided in addition to the warrant for verification.

As described above, the warrant may be signed using a private part of a warranting key. A public part of the warranting key may then advantageously be provided to third parties to enable them to verify the warrant, for example by verifying that the signature on the warrant is correctly formed.

In a further aspect of the invention, a security module may be used by a key generator to generate one or more new cryptographic keys. When it does so, the module may generate a key-generation certificate, which may be used in association with an existing warrant for the security module to verify, or attest to, the origin of the new key or keys.

The verification process may be carried out by a prover, who receives or is in possession of the key-generation certificate and the module warrant. In addition, the prover may receive the newly-generated key, if the key-generation certificate contains, for example, cryptographic hash values or other digests for identifying the key, rather than the key itself. The prover may similarly receive any other information associated with, and identifiable with reference to, any cryptographic hash values or other digests incorporated in the key-generation certificate or the module warrant. If appropriate, the prover may also receive any intermediate signed status messages generated by the module if the warrantable key is used, for example, for signing a message identifying an intermediate key for signing the key-generation certificate, or for initiating more than one level of indirection terminating with the signature of the key-generation certificate; under such circumstances, the key-generation certificate may be considered to be indirectly signed by the warrantable key.

If the warrant has been signed using the private part of a warranting key, the prover will also receive, or be in possession of, a public part of the warranting key. This will advantageously have been obtained from the warranting authority through some trusted channel (for example, a secured physical transfer, some other cryptographically-secured electronic channel, face-to-face contact between trusted parties or some other basis for trust).

According to a preferred embodiment of the invention, the prover then ensures that the public key in, or identified in, the warrant (the warrantable key) correctly validates the signature on the key-generation certificate. Preferably, the prover also checks that the key-generation certificate message is correctly formed.

If the prover has received any intermediate signed status messages generated by the module, the prover will ensure that the public key identified in the warrant validates the first status message, that the signatures on the or each intermediate status message is or are validated by a key in a previous status message, and that a key in the last status message validates the signature on the key-generation certificate.

Preferably, the prover carries out the following checks; that the public key in, or identified in, the warrant (the warrantable key) correctly validates the signature on the first of the status messages; that the first status message is correctly formed; that the signatures on any intermediate status messages validate correctly against the public key in, or identified in, each respective previous status message and that each intermediate status message is correctly formed; that the signature on the last status message is valid; that the last status message is correctly formed; that the public key in or identified in the last status message correctly validates the signature on the key-generation certificate; and that the key-generation certificate message is correctly formed.

The prover may then check that the key identified in the key-generation message matches the identification of the newly-generated key.

The aim of these activities of the prover is ultimately to convey a validation of the new key to a consumer. This may be done in a number of different ways, either directly or though an intermediate, such as a certification service.

If the prover concludes that the key was correctly generated by, or inside, the warranted security module and, if applicable, that it was generated with the parameters that are represented in the key-generation certificate, the prover can communicate this conclusion to the consumer or certification service. This may be done in any appropriate way, for example either by passing over the key identifier (which may be the key itself or a hash value or digest), or by simply informing the consumer or certification service that the prover's tests have concluded that the key was correctly generated.

If the consumer receives this information directly, then it may make use of the information in any way that it sees fit.

In a further aspect of the invention, a certification service receives and accepts the conclusions of the prover. The certification service may then issue a certificate identifying the key and asserting its worthiness, on the basis of the chain of verification and evidence deriving from the activities of the warranting authority and the prover. The certification service may additionally carry out other validation processes, if desired, for ascertaining other information about the newly-generated key and/or its holder and/or its intended use. Such information may be included in the certificate, which would then attest both to the worthiness of the key as asserted by the prover and to the other information.

The certification service may sign the certificate using a private part of a certification key. The consumer may then be able to validate the certificate using a public part of the certification key, obtained from the certification service or from a public record by any appropriate means.

As noted above, although the invention in its various aspects has been described in terms of a manufacturer, a warranting authority, a key generator, a prover, a certification service and a consumer, not all of these roles may exist in any particular embodiment of the invention, and more than one of these roles may be carried out by the same person or organization.

For example, the manufacturer may also act as the warranting authority in order to generate a warrant for a security module which may subsequently be used to validate key-generation certificates generated by that module.

Alternatively, a warranting authority separate from the manufacturer may be used to issue a warrant attesting to the level of security offered by a particular security module.

The prover may be the same party as either the consumer or the certification service. For example, if a consumer wishes to know about the source of a key, he may carry out the activities of the prover himself. Similarly, before a certification service issues a certificate, it may carry out the activities of the prover to validate the key identified in the certificate.

Different parties may also be located in different places. For example, the services of the prover may be implemented as an on-line service on the internet or other network.

It should be noted that references to a manufacturer may include, for example, a combination of organizations such as a designer and an original equipment manufacturer (OEM).

Thus, it can be seen that the invention in its various aspects may advantageously enable a reliable chain of evidence from a security module to a consumer using a key generated by that module. Advantageously, this may enable verification of a private key through an audit process or verification of a public key through a certification process, for example.

### BRIEF DESCRIPTION OF THE SEVERAL VIEWS OF THE DRAWING(S)

Specific embodiments of the invention will now be described by way of example, with reference to the accompanying drawings, in which:

FIG. 1 illustrates diagrammatically a warranting method embodying the invention.

### DETAILED DESCRIPTION OF THE INVENTION

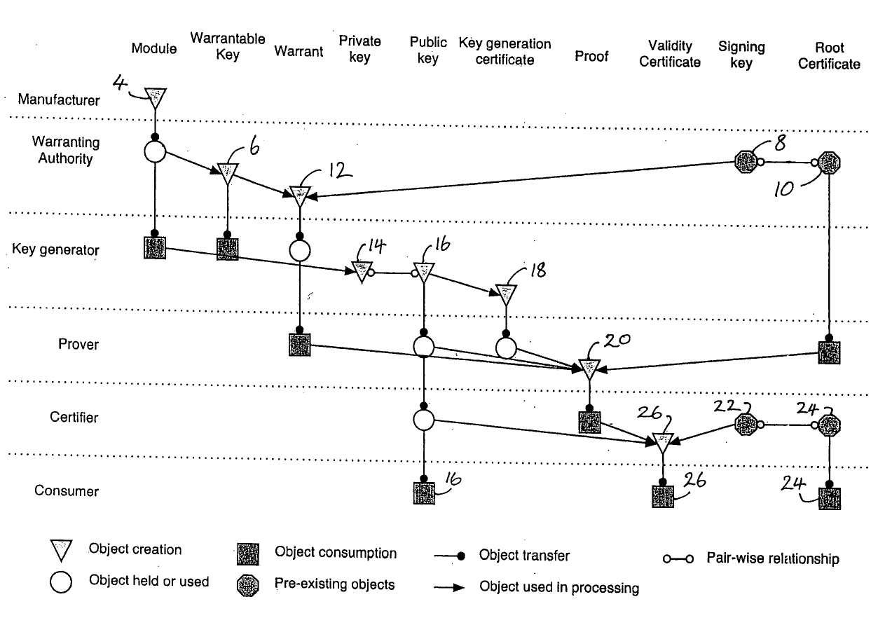

As illustrated in FIG. 1, a manufacturer designs and manufactures a module 4, which may be a tamper-proof hardware or software security module. The module securely holds a private part of a key, which can only be used for signing messages generated within the module. A corresponding public part of the key can be extracted from the module.

The module is passed to a warranting authority, together with design details for the module. The warranting authority inspects the module, ensuring that it meets the design criteria and that it holds, to a predetermined level of security, the private part of the key for signing messages generated within the module. The warranting authority extracts the public part of this warrantable key 6 and generates a warrant message incorporating an identification of the public part of the warrantable key.

The warranting authority is in possession of a warranting key. The private part of the warranting key is termed a signing key 8 in FIG. 1, and the public part of the warranting key is termed a root certificate 10. The warranting authority signs the warrant message using the signing key to generate a warrant 12.

The warranting authority then passes the warranted module 4, the public part of the warrantable key 6 and the warrant 12 to the key generator, who uses the module to generate a new key comprising a private part 14 and a public part 16. The module retains the private part and generates a key-generation message containing information pertaining to the public part. It signs the key-generation message using the private part of the warrantable key to produce a key-generation certificate 18.

The module may incorporate the public part of the new key into the key-generation certificate or it may incorporate a hash value or other digest to enable a third party to identify the public part of the key using the key-generation certificate. The key-generation certificate may also include additional information pertaining to the key, such as the cryptographic strength of the key-generation process and any access control parameters pertaining to the key.

The module may sign the key-generation certificate using the warrantable key either directly or indirectly through one or more levels of indirection, for example by using a bunch, or set, of intermediate keys to sign intermediate status messages before using a final key to sign the key-generation certificate itself.

A prover receives the warrant 12, the public part of the new key 16 and the key-generation certificate 18 from the key generator, and the root certificate 10 (the public part of the warranting key) from the warranting authority. It preferably receives the root certificate through a trusted channel or other secure route.

The prover uses the root certificate to validate the signature on the warrant, and checks that the warrant is correctly formed. It then uses the public part of the warrantable key, which was either contained in or identified in the warrant, to validate the signature on the key-generation certificate. If the key-generation certificate has been signed by the warrantable key indirectly, through levels of indirection, the prover must follow through the levels of indirection, checking at each level that the respective intermediate key properly validates the corresponding status message and that the status message is correctly formed.

If the prover can validate the signature on the key-generation certificate and that the key-generation certificate is correctly formed, it creates a proof message 20. This may also incorporate information from the root certificate 10 to identify the warranting authority involved.

The prover passes the public key, together with the proof message, to a certification service (certifier). If appropriate, the proof message may be signed by the prover to enable secure transmission to the certification service. In many instances, however, the prover and the certification service may be the same party, so that secure transmission is not required.

The certification service is in possession of a certification key, comprising a private part 22 and a public part 24, respectively termed a signing key and a root certificate in FIG. 1. The certification service checks that the proof message correctly identifies the public part of the new key and contains appropriate assurance as to the validity of the key, and signs the certification message using the private part of the certification key to produce a validity certificate 26.

A consumer wishing to use the new key receives the public part of the key, the validity certificate and the root certificate (the public part of the certification key) from the certification service. The consumer can use the root certificate to check that the validity certificate is correctly signed and that the certificate correctly identifies the new key. The consumer then relies on its trust in the certification service as a basis for trusting the chain of evidence stretching back to the security module and the manufacturer. The certificate may also contain details of the module, such as its design or the level of security it offers, as well as access control information, from which the consumer can assess the level of cryptographic security offered by the new key. The certificate thus attests to the chain of evidence stretching back through the activities of the certification service, the prover, the key generator and the warranting authority involved in generating the new key and passing it to the consumer.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A cryptographic security module, in which a private part of a cryptographic key is held and from which a public part of the cryptographic key can be extracted, and in which the module can generate a new key, the private part of the cryptographic key being usable to generate a key-generation certificate by signing, either directly or indirectly through one or more levels of indirection, a key-generation message containing information by which the new key can be identified.

2. A security module according to claim 1, in which the cryptographic key is a warrantable key, the private part of the cryptographic key being usable only to sign messages generated within the module and the public part being usable by a warranting authority to generate a warrant.

3. A security module according to claim 1, in which the private part of the cryptographic key can be used to sign a status message containing information sufficient to identify, either directly or indirectly, a key for signing the key-generation message.

4. A security module according to claim 1, in which the key-generation certificate additionally contains information pertaining to parameters used for generating the new key.

5. A security module according to claim 1, in which the key-generation certificate additionally contains information pertaining to parameters used for generating access-control parameters attached to the new key.

6. A security module according to claim 1, implemented as a hardware security module.

7. A security module according to claim 1, implemented as a tamper-proof software security module.

8. A method for operating a security module, comprising the steps of;
holding a private part of a cryptographic key in the module;
using the module to generate a new key;
generating a key-generation message pertaining to the generation of the new key; and
generating a key-generation certificate by using the private part of the cryptographic key to sign the key-generation message, either directly or indirectly through one or more levels of indirection.

9. A method according to claim 8, in which the cryptographic key is a warrantable key and the private part of the cryptographic key is usable only to sign messages generated within the module, further comprising the steps of;
extracting a public part of the cryptographic key from the module; and
generating a warrant as evidence that the module contains the warrantable key.

10. A method according to claim 8, further comprising the step of using the private part of the cryptographic key to sign a status message containing information sufficient to identify, either directly or indirectly, a key for signing the key-generation message.

11. A key-generation certificate generated by a method as defined in claim 8.

12. A method for warranting a cryptographic security module, comprising the steps of;
ascertaining that the module holds a warrantable key, comprising a private part held within the module and only usable to sign messages generated within the module, and a public part which is extractable from the module;
generating a warrant message identifying the public part of the warrantable key and the module; and
signing the warrant message using a private part of a warranting key to generate a warrant.

13. A method according to claim 12, further comprising the step of authenticating the module against a predetermined standard, the generation of the warrant indicating that the module meets the predetermined standard.

14. A method according to claim 12, further comprising the step of using a public part of the warranting key to validate the warrant.

15. A method according to claim 12, in which the steps of ascertaining that the module holds a warrantable key, and generating and signing the warrant message are carried out by a warranting authority.

16. A warrant generated according to a method as defined in claim 12.

17. A method for verifying that a cryptographic key has been generated by a predetermined cryptographic security module, being either a specific, identifiable module or a module of a predetermined type or complying with a predetermined standard, comprising the steps of;
receiving a key-generation certificate purportedly (i) generated in the predetermined module, (ii) containing information from which the key can be identified and (iii) signed by a private part of a warrantable key held in the predetermined module;
receiving a warrant identifying a public part of a warranted key and warranting that it was extracted from a module which has been inspected by a warranting authority; and
verifying that the public part of the warranted key validates the key-generation certificate.

18. A method according to claim 17, further comprising the steps of;
receiving a public part of a warranting key; and
verifying that it validates the warrant.

19. A method according to claim 17, further comprising the step of;
issuing a certificate certifying that the key-generation certificate has been validated.

20. A method according to claim 18, further comprising the step of;
issuing a certificate certifying that the key-generation certificate and the warrant have been validated.

21. A cryptographic key validation certificate generated by a method as defined in claim 19.

22. A cryptographic key validation certificate generated by a method as defined in claim 20.

23. A method for verifying the origin of a cryptographic key purportedly generated by a predetermined cryptographic security module, comprising the steps of;
receiving a certificate certifying that the key was generated by the module, the certificate having been generated by the following steps;
inspecting the module and ascertaining that it holds a warrantable key, comprising a private part held within the module and only usable to sign messages generated within the module, and a public part which is extractable from the module;
generating a warrant message identifying the public part of the warrantable key and the module;
signing the warrant message using a private part of a warranting key to generate a warrant;
receiving a key-generation certificate generated in the module, containing information from which the key can be identified and signed by the private part of the warrantable key;
receiving the warrant identifying the public part of the warrantable key and warranting that it was extracted from the module after inspection by a warranting authority;
verifying that a public part of the warranting key validates the warrant;
verifying that the public part of the warrantable key validates the key-generation certificate; and
issuing the certificate.

24. A cryptographic security module, in which a private part of a warrantable key is held and from which a public part of the warrantable key can be extracted, the private part being usable only to sign messages generated within the module and the public part being usable by a warranting authority to generate a warrant.

25. A security module according to claim 24, in which the module can generate a new key, and the private part of the warrantable key can be used to generate a key-generation certificate by signing, either directly or indirectly through one or more levels of indirection, a key-generation message containing information by which the new key can be identified.

26. A method for operating a security module, comprising the steps of;
holding a private part of a warrantable key in the module, the private part being usable only to sign messages generated within the module;
extracting a public part of the warrantable key from the module; and
generating a warrant as evidence that the module contains the warrantable key.

27. A method according to claim 26, further comprising the steps of;
using the module to generate a new key;
generating a key-generation message pertaining to the generation of the new key; and
generating a key-generation certificate by using the private part of the warrantable key to sign the key-generation message, either directly or indirectly through one or more levels of indirection.

28. A cryptographic security module comprising:
a first memory region that stores a private part of a cryptographic key;
a second memory region that stores a public part of the cryptographic key;
logic that generates a new key, the private part of the cryptographic key being usable to generate a key-generation certificate by signing, either directly or indirectly through one or more levels of indirection, a key-generation message containing information by which the new key can be identified.

29. The security module according to claim 28, in which the cryptographic key is a warrantable key, the private part of the cryptographic key being usable to sign messages generated within the module and the public part being usable by a warranting authority to generate a warrant.

30. The security module according to claim 28, in which the private part of the cryptographic key signs a status message containing information sufficient to identify, either directly or indirectly, a key for signing the key-generation message.

31. The security module of claim 28 wherein the first memory region is a hardware memory.

32. The security module of claim 28 wherein the first memory region is a firmware memory.

33. The security module of claim 28 wherein the first memory region is a software memory.
